(19) United States
(12) Patent Application Publication
(10) Pub. No.: US 2015/0281744 A1
(43) Pub. Date: Oct. 1, 2015

(54) VIEWING SYSTEM AND METHOD

(71) Applicant: Karen CHAPMAN, New York, NY (US)

(72) Inventor: Karen CHAPMAN, New York, NY (US)

(21) Appl. No.: 14/675,320

(22) Filed: Mar. 31, 2015

Related U.S. Application Data
(60) Provisional application No. 61/972,700, filed on Mar. 31, 2014.

(51) Int. Cl. H04N 21/218; H04N 21/2187; H04N 21/4728; H04N 21/4402; H04N 21/472; G06F 3/0354; H04N 21/422

(52) U.S. Cl. CPC H04N 21/21805; G06F 3/03547; H04N 21/2187; H04N 21/42224; H04N 21/44029; H04N 21/47205; H04N 21/4728

(57) ABSTRACT

A method and system for viewing a stage performance captured by a video camera with encoder for streaming wherein a live stream of images received from the camera over the Internet or by other means is manipulated using a touchplate to permit the viewer of the performance on a remote display screen for example to pan across the image or zoom in or out on particular aspects of the images being displayed so that only a portion of the image stream received is displayed on the display screen.

### RELATED APPLICATION

The present application claims priority from U.S. Provisional Application Ser. No. 61/972,700 filed on Mar. 31, 2014, the contents of which are incorporated herein by reference.

### FIELD OF THE INVENTION

The present invention relates to a viewing system permitting the viewer of a transmission of a live event to adjust the view seen on his or her display monitor, for example by “zooming in” on particular parts of a transmitted image and focusing on only a part of the transmitted image.

### BACKGROUND OF THE INVENTION

Live events such as opera, ballet, concert, dance, lieder and theatrical performances are televised or streamed using multiple cameras and multiple perspectives. The image transmitted is a “feed” selected from multiple camera shot options by the technical director, editor, director or producer. The viewer has no choice as to what part of the stage he or she views. The camera shot, selected by the technical director, editor, director or producer, of a particular performer or area of stage, is provided to the viewer. This selection process is an integral part of the art of film and television, based on a technology model over a century old. The model is not appropriate for broadcasting live stage performance. The art of live stage performance, millennia old, whether theatre or dance or lieder or opera or orchestra, is created for view by individual seated audience members, from one angle, even if the stage is round.

Viewing stage performance is akin to reading. Viewers substantially co create, their unique experiences and thought fill in numerous blanks and determine their focus, what they individually follow and where they look onstage. A fine performer on a bare stage can create an unforgettable memory, a powerful illusion of reality, for the viewer. Every camera cut created by another's consciousness, in varying degrees breaks that illusion and substantially reduces a performances power.

The present invention allows the viewer, rather than the technical director, director or editor, to view what he or she wants to see by transmitting a single video image from a well-positioned immobile high definition video camera with stage specific lens to a network's servers which transmit the streaming video images to their subscribers via broadband providers. The present invention provides means typically to a subscriber of an internet streaming network to control whether the entire received image or a section of that image is viewed while watched. Typically, this will be accomplished by the use of a monitor connected to a separate device, such as a handheld plate that will enable a viewer to manipulate the image stream. The invention includes software that will provide the capability of seamless screen manipulation of streamed live performances as if the viewer was actually attending the live performance in person.

Thus, the present invention will replicate actual presence at a performance where a member of the audience can look at whatever part of the performance most interests him or her at any particular time. Stage performances are created to be viewed live, only at the time of performance. Streaming allows this. Encryption can prevent unauthorized downloading of the streamed video. The present invention allows the seamless manipulation of a live static camera feed viewed on a display screen by a wired or wirelessly tethered touchplate. The live static camera feed is captured by a single immobile camera and the live static camera feed is provided by an internet streaming network that grants access to the streaming video to subscribers of the network.

Bratton et al. U.S. Pat. No. 8,340,654 discloses an apparatus and method for display and control of video data on a mobile device providing simultaneous multiple video data display of groups of video sources and selection of video data for single, larger viewing. Control of the camera source of the video data is provided for the mobile device user, such as by manipulation of a multi-touch sensitive screen to pan, tilt and zoom. Image capture from the video screen and marking of the captured image is provided.

Ortiz et al. U.S. Pat. No. 7,149,549 discloses a hand held device and system for receiving venue-based data at the hand held device. Data are transmitted form one or more venue-based data sources. Such data may be processed for display on a screen associated with a hand-held device. A touch screen display area of display screen can be arranged with graphical icons and/or user-controls that perform specific pan and zoom functions. Such icons/user-controls, when activated by a user, permit the user to view panned/zoomed images of events taking place in real time within the venue. Screens “associated with” a hand-held device include those of Personal Digital Assistants and what are now called smart phones. The user controls may include a touch screen capability on the display screen, but without pinch-zoom, swipe to move.

Kanayama et al. U.S. Published Application 2006/0007318 discloses an image captured by a monitoring camera stored in an image database in a monitoring system center apparatus, and is subsequently transmitted as an entire image to a cellular phone. When a user checks the image displayed on the cellular phone and determines that there is an object that the user desires to display in enlarged form, the user accesses and instructs a webpage provided by the center apparatus to display an enlarged display menu.

Green et al. U.S. Pat. No. 8,489,065 discloses a method for using any mobile device to manage a security system in retail environments in which an application or applet is installed on the mobile device providing a GUI for users to easily perform functions allowable by the security system. This method can be added to any legacy security system providing remote control and monitoring of the system via two-way communication links. The mobile device allows the user to use pre-defined gestures on a touch screen, or use air gestures, to operate the application including a single tap on any icon to activate the icon function and move to an appropriate screen, the ability to view a graphical representation of the security system whereby the user can use zoom, pan, and scroll functions on the touch screen to view any desired portion of the graphically represented security system, to view live streaming video from any camera by one gesture touch or air gesture on the camera.

However, no prior teaching or suggestion in the prior art is found for taking feed from a single camera at performance and using a device separate from the screen or monitor on which the performance is to be viewed to select the portions of the feed that are being viewed. Use of a separate device to enable selection of the feed to be viewed avoids the need to put hands on the screen and thus interrupt the flow and view of stage or one angle-preferable performance.

For audiences, the ability to focus on what they want to see on stage is vital to experiencing a performance. A satisfactory system for broadcasting theatre and stage performance does not exist. Multiple cameras require extra rehearsals, disrupt the performance for audiences and can often alter stage performance, but a one-camera static broadcast removes the emotion and excitement of experiencing a live performance. It's boring.

The present invention allows virtual attendance at live stage events by providing the capability for a virtual audience member to “flip” viewing preferences of the live performance. This is revolutionary for live performance broadcasting. Like a seated audience member, a virtual audience member is able to look at an actor or costume or section of stage, as desired, real-time, without the dictates of a technical director in theatre choosing camera shots. And the virtual audience member can attend a performance as it happens, one that can never be seen again.

People all over the world will have the opportunity to watch live performance including theatre, opera, ballet, and concerts as if they are in the audience.

The present invention allows the feed, whether provided by one immobile ultra-high definition camera or 4K or higher rated camera with stage specific lens at stage performance (i.e. encompassing stage height, width and depth), or by a video camera capturing a live event, to be viewed as desired by end receivers while being watched, whether watched live or recorded. The end receiver chooses zoom and area of field.

Typically, multiple cameras, a production switcher, and encoder are used when transmitting images to a network's servers, or a streaming host website's servers. Multiple cameras and a production switcher with associated equipment are expensive, complex and bulky for individuals wanting to include family and friends at live streamed amateur or family events. The present invention eliminates the need for multiple camera complexity, interruption and expense for streaming live events. The present invention provides for display screens to be equipped with the capability for manipulation of a live video stream while families and friends view streamed, live school and family events from separate locations.

### SUMMARY OF THE INVENTION

From a first aspect, the present invention provides a method for viewing a stage performance captured by a video camera with encoder for streaming wherein the method comprises receiving a static framed live stream of images from said camera by a receiver comprising a display screen (examples may include smart TVs, computers, iPads).

Tethered to said receiver is a separate touchplate that controls which parts of said streaming images are displayed on the display screen by allowing manipulation of the streamed static-framed moving view by hand on the touchplate, similar to the manipulation of a photo on a smart phone.

“Touchpad” and “trackpad” typically denote complex devices with broad functionality. The 2011 HP Touchpad was compared to the original iPad. A trackpad generally refers to the touch area on a notebook that controls computer functions, like a mouse.

We use the word touchplate to denote a hardware device, created or adapted, that simply controls the area viewed of a static framed streamed moving image as received by a separate monitor. This ability can be incorporated into an existing device (such as a smart phone as a specific app for example), via a software update (or download). Typically the touchplate is separate from the viewing monitor. When incorporated into a device having other functionality, such as a television remote controller, the use of the device in the present invention is distinct from other functionality possible on the device.

The video camera may typically be an ultra-high definition video camera or a video camera of even higher definition such as 4 k or 5 k provided with a stage-specific lens, although in some situations, this may not be required and a camera with lower definition and/or a general purpose lens may be used. All that is required is that the camera, at whatever quality resolution the user requires, is capable of capturing the entire event from a single location without needing to move the camera.

Although this invention is described using a single camera in a fixed position, it will be understood that if it is desired to transmit and view images in three dimensions, additional fixed position cameras will be employed and data from those cameras will be streamed and transmitted simultaneously through the system to the user.

Such streaming from the encoder to the receiver may be accomplished in any convenient way, for example by means of network servers and other broadband providers. In some situations, for example where an “overflow audience” is viewing an event in a separate location from that in which the event is taking place, the stream may even be provided direct from the encoder to the receiver.

By use of the internet, a network or over-the-air supply of the data stream, it is possible for multiple users to view the same performance, using their own touchplates to manipulate their own feed of the same basic data stream at their own location on their own viewing monitors. The touchplate may communicate wirelessly or through a wired connection with the receiver to control the display by manipulating how much of the incoming signal the user wishes displayed on the screen. Manipulation of the incoming signal by the touchplate allows for dynamically variable suppression of the signal that is not displayed, similar to the “magnifier” approaches commonly seen for images.

From a second aspect the present invention provides a system for viewing an event captured from a single perspective as a stream of images captured by one or more cameras, which system comprises a touch plate, and a receiver, linked to a display screen. The receiver transmits the stream of images to the display screen. The touch plate permits manipulation of the images being transmitted from the receiver to the control screen. The display screen may be a television, a monitor or other screen associated with the receiver.

In both aspects, downloadable receiver specific software, or pre-installed software provides pinch to zoom and swipe to move capability for seamless screen manipulation of live performances and events, allowing the viewer to choose what is focused on and followed, to watch as he or she would if actually attending the live performance or event in person.

### BRIEF DESCRIPTION OF THE DRAWING

FIG. 1 is a schematic diagram of a simple form of the system.

FIG. 2 is a schematic diagram of a system in which a smart TV, that is a television wherein the main screen that has embedded applications that can be programmed and can perform functionality such as IRI, IMM, RNI as defined below, is employed. A similar arrangement may be used for other equipment having a “smart screen” having embedded applications that can be programmed and perform functionality such as a tablet or other computer monitor.

FIG. 3 is a schematic diagram of a system in which images are received and then transferred to a separate screen, is employed (including such devices as game consoles, Roku and Apple TV).

FIG. 4 is a schematic diagram of a system in which a proxy-based system wherein the device is networked, and various modules above (such as IRI, IMM, RNI as defined below) are located in the cloud, is employed.

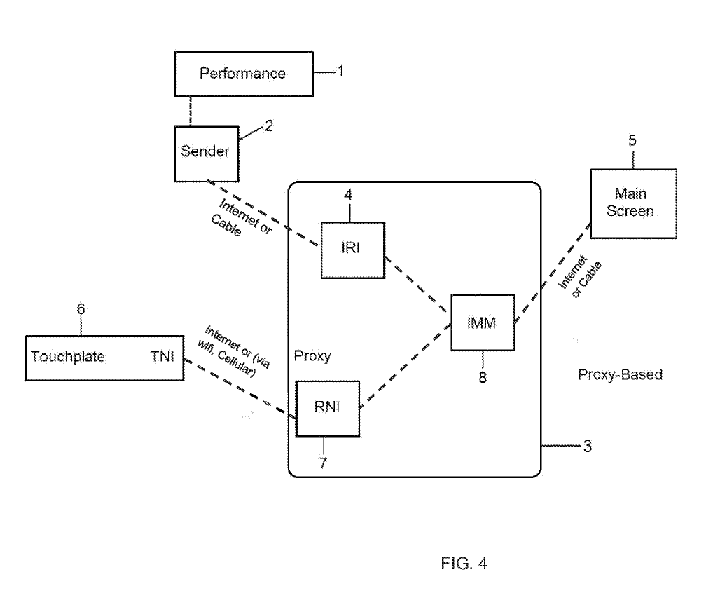

The following abbreviations are used in all the figures:

IMM—Image Modifier Module: Can take the original video image from the transmission and convert it to what should be displayed on a user's screen, for instance, by taking the originally transmitted image and zooming into a particular region of this image, and recasting the zoomed portion to fit the entire display. This feature is often incorporated into smart TVs, or into computer software used for playing videos. For instance, the video playback software package VLC implements a zoom feature that allows a user during video playback to click on the portion of the played back image to magnify and redisplay. The IMM contains similar software that enables magnification and redisplay of a portion of the viewed image. The set of signals sent by the touchplate are received, described in digital form, from the RNI, and the record is stored by the IMM such that the IMM maintains the sequence of modifications of the display of the broadcast that is requested by the viewer. The set of sequences, along image modification software, allows the IMM to receive a video image, and perform the appropriate set of transformations as described by the digital transmissions received by the RNI, to display the image as desired by the user.

IRI—Image Receiver Interface (IRI): where the transmitted image (from the sender) first arrives, without any modification.

RNI—Receiver/touchplate Network Interface: receives signals from the touchplate, and will use those signals to modify the image.

TNI—Touchplate Network Interface: part of the touchplate, sends signals from the touch plate to a network.

### DETAILED DESCRIPTION OF THE INVENTION

In the following description, reference is made to the accompanying drawing which form a part hereof, and which is shown, by way of illustration, several embodiments of the present invention. It is understood that other embodiments may be utilized and modifications may be made without departing from the scope of the present invention.

The system of the present invention comprises at least the following components: Main or display screen: where the main image is to be displayed.

Sender: the device at the point of origin in the network where the image is transmitted, typically a high resolution video camera.

Image Receiver Interface (IRI): where the transmitted image (from the sender) first arrives, without any modification.

Image Modifier Module (IMM): Can take the original video image from the transmission and convert it to what should be displayed on a user's screen.

Touchplate Network Interface (TNI): part of the touchplate, sends signals from the touch plate to a network.

The touchplate must have a network interface (TNI) that it can use to send digital representations of finger movements. This interface can be over Wi-Fi, Bluetooth, USB if the RNI is local, or via the internet if proxied. Receiver network interface to receive signals from the touchplate network interface.

Touchplate capability may be provided to smartphones or smartpads via software downloaded as an app, provided as an update to an existing smartphone or smartpad app (such as an app providing specific network access, like Netflix) or built into smartphones, smartpads, and television and monitor remotes.

A touchplate may be created singularly for its purpose, comfortably handheld by virtual audience members, allowing individuals to seamlessly follow performance being viewed on their smart TV or computer or other viewing monitor. It may be round or square, or any shape comfortably held, perhaps 4 to 5 inches in diameter or width. It may be created with smooth, wear resistant glass. It can be elegantly designed to be aesthetically pleasing set on an end table when not in use. It will be an unconscious extension of the viewer as they focus on and move with a performance, like one unconsciously moves a steering wheel when driving a car.

A direct physical contact with the touchplate may not be needed if the touchplate incorporates technology to permit sensing of movements by the user, for example the functions of the touchplate may be accomplished by cameras or other forms of motion detector located in a smart TV or elsewhere which can sense movements of a user's hand. The TNI communicates with a Receiver/touchplate Network Interface (RNI): this is the networked side of a device/module that expects to communicate with the touch plate.

The RNI communicates (probably directly, i.e., within the same component) with the Image Modifier Module (IMM) which takes the image and adjusts it (e.g., enlarges the selected part) as specified by the sequence of actions indicated on the touch plate.

The Image Modifier Module (IMM) receives the incoming (unmodified) video signal from the IRI (Image Receiver Interface), and modifies it, as it was instructed to do by the signals it received from the RNI. It sends the signal to the display for viewing.

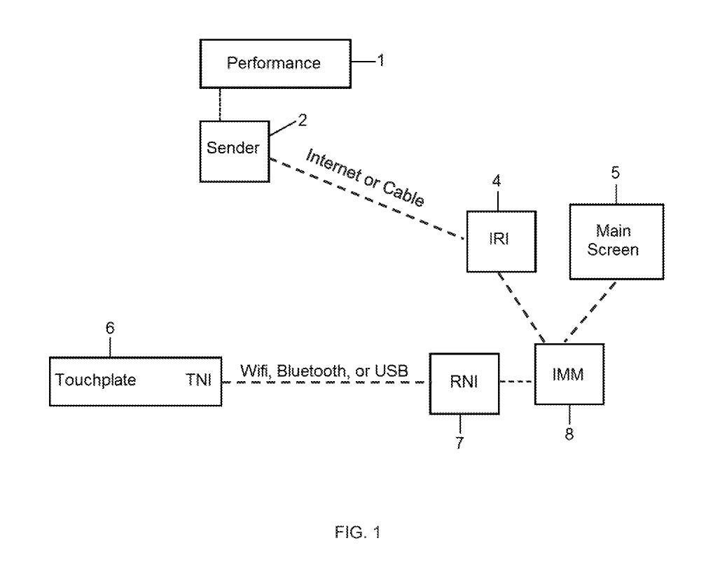

Referring now to FIG. 1 which depicts one embodiment of the invention, an event (1), is captured by a video camera which acts as a sender (2) and data representing the captured images is transmitted, typically as streamed data means for forwarding the data stream to a user, such means being typically a server or to “the cloud” 3. Such transmission may be, for example over the Internet, via cable or wireless signal. The streamed data is then transmitted to one or more receivers each having an image receiver interface (4) coupled to a display screen (5). The image displayed on the display screen is manipulated (zoomed, panned, etc.) by use of a touchplate 6 through which a user creates commands to be sent, for example through Wi-Fi, Blue tooth or a USB connection to an receiver network interface (7) coupled to an image modifier module (8) of the receiver coupled to the display screen (5) so as to instruct which parts of the incoming streamed data are to be utilized to produce an image on the screen (5). If desired, audio from the event may be packaged with the video data or may be transmitted Separately. In one way of performing the method of the present invention, images of events such as live stage performances including theatrical, operatic, dance, lieder and orchestral performances, are streamed from a single high-performance wide angle video camera. As noted above, for other uses, cameras of lower quality may be employed. The streaming images obtained from such camera are transmitted to the user in any convenient manner as “whole images” and may include digital transmission as data encoded such images. If desired, the data may be encrypted. Such transmission may be by cable, or wirelessly. Typically the data will be transmitted digitally. However, the method of the present invention can also be used to manipulate data in analog form, for example by use of the touchplate to control which portions of a line or frame are to be displayed. The method of the invention may be used with digital television (DTV) broadcast via digital satellite or via free over-the-air (OTA) digital terrestrial television much like analog television broadcasts have been.

The present invention comprises a display screen operatively linked to a receiver capable of receiving transmitted video data. Such data may be transmitted through a general means of distribution such as a cable or fiber network, through a smaller system such as a local or wide area computer network, via a wireless medium such as cellular or Wi-Fi, or any combination of these technologies. The receiver can be a separate device that plugs into the display screen or can be a built-in component of the display screen. The receiver can communicate with the various components of the display screen such as the central processing unit (CPU), image processing unit and memory units. In cases where data encoding the images are supplied in encrypted form, such display screen may include a processor programmed to decrypt the incoming data. Furthermore, encryption may also be used to restrict subscribers from downloading the streaming video image.

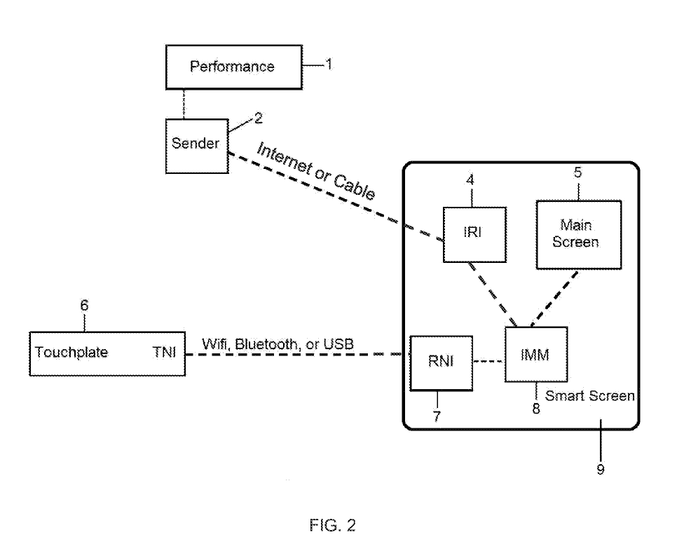

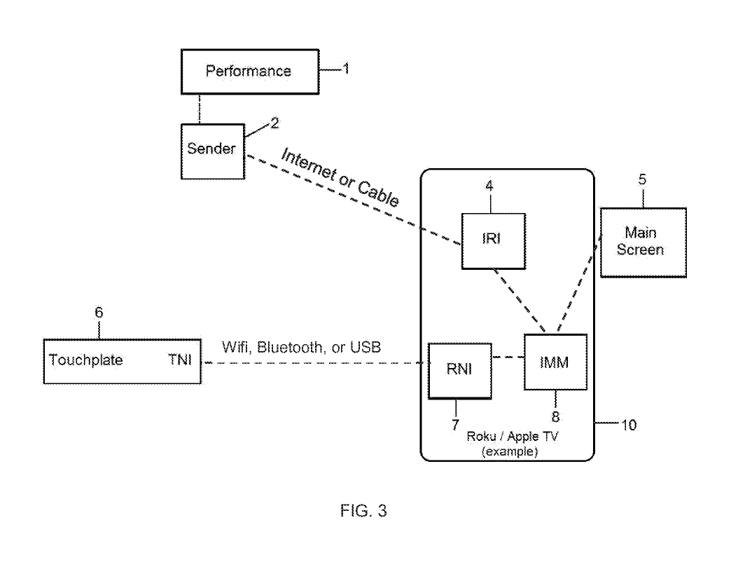

In another embodiment depicted in FIG. 2, the display screen (5), the IRI (4), the RNI (7) and the IMM (8) are all contained in a smart screen (9). In a further embodiment depicted in FIG. 3 the IRI, RNI and IMM are contained in a single device such as a Roku (10) which feeds a separate display screen.

It is also possible for the IRI, IMM and RNI modules to be located in the cloud (3) to provide a feed to the display screen, in this case communication between the touchplate and the RNI typically being through the Internet (Wi-Fi or cellular).

In one embodiment of the present invention, live streaming video is received by the display screen via the internet. The display screen is thus capable of connecting to the internet such that a user is able to stream live video from an internet source. The internet connection may be provided through an Ethernet cable connected to the display screen or through a wireless WIFI connection. The internet source from which the live streaming video is obtained may include a streaming network where a user pays a fee to be a subscriber. The internet source may also include regular websites where no fee or subscription is required. In this embodiment, the display screen will have a receiver for receiving internet content. The receiver can be a separate device that plugs into the display screen or can be a built-in component of the display screen. The receiver can communicate with the various components of the display screen such as the central processing unit (CPU), image processing unit and memory units.

The present invention may include an internet based video broadcasting system (or network such as Netflix or Sling TV) having multiple channels of live streaming video. The internet based video broadcasting system operates in a manner which resembles a television broadcast as normally provided on a television set. The system may include at least one webpage or homepage which has a channel listing portion providing multiple channels which can be selected for viewing live streaming video of a theatrical, operatic, dance, lieder or orchestral performance. The homepage may be provided with a media player window, a channel listing area, one or more advertising media areas, and one or more search field areas. The present invention may include a host system for simultaneously communicating with one or more user devices via a network. The network can be the internet or other network. In either case, the host system may include one or more servers configured to communicate with multiple user devices via the network using a one-to-many communication paradigm, for instance via multicast, or via one or more gateways. When the network is the internet, the primary user interface of the system is delivered through a series of web pages, but the primary user interface can be any other type of interface, such as a Windows-based application permitting users to access or interact with the host system graphically, textually, or audio visually.

A method in accordance with the present invention may comprise coupling a display screen to a transmission station, the transmission station receiving a plurality of live video feeds, arranging a plurality of icons on the display screen to provide a layout for selecting a particular live video stream, associating a live video feed of the plurality of live video feeds with an icon of the plurality of icons, enabling a user to select a live video feed by selecting the icon associated with that live video feed, displaying the live video feed onto the display screen, enabling the user to manipulate the view of the live video feed by moving their fingers on a separate remote control device connected to the display screen.

A system in accordance with the present invention may comprise a computer having a monitor and a transmission station, coupled to the computer, for receiving a plurality of live video feeds, wherein the monitor displays a plurality of icons associated with the plurality of live video feeds, the computer associates a live video feed of the plurality of live video feeds with an icon of the plurality of icons, and the computer is capable of selecting a live video feed of the plurality of video feeds and manipulating the selected live video feed based on inputs from a separate remote control device connected to the computer and monitor.

It is, of course possible for the display screen and computer to be incorporated into a single device such as a tablet if desired. Indeed even the touchplate can be incorporated into such a device. If this is done, it is desirable that the touchplate be separate from the display screen so that manipulation of the image does not require that the user's fingers block the viewing of the image while manipulation is taking place.

In another embodiment of the present invention, the touchplate communicates wirelessly to the receiver. An additional embodiment has the touchplate incorporated into the remote control of a TV for manipulating the view of a live stage performance being viewed on the TV.

The present invention may be implemented by a computer-implemented program, wherein the program is represented by a window displayed on the computer monitor or display screen. The program may comprise an internet browser which enables a user to access various webpages on the internet. The program will comprise of logic and/or data embodied in or readable from a device, media, carrier, signal, one or more fixed and/or removable data storage devices connected directly or indirectly to the computer, or one or more remote devices coupled to the computer via a data communications device.

The computer may also be connected to other computers through a network comprising the internet, Local Area Networks (LANs), Wide Area Networks (WANs), or other networks, either wired or wireless or some combination therein. The database may also be integrated within the computer or may be located across a network on another computer or accessible device.

In another embodiment of the present invention, mobile computing devices with embedded display screens may be used for viewing, such as Personal Data Assistants (PDAs) or other devices. In another embodiment, the user device can be a cable-television box or other similar device such as a Web TV appliance, for viewing through a monitor or television. Current embodiments of the system can also be modified to use any of these or future developed devices.

The system is designed to be flexible so that depending on the requirements of the particular embodiment, the system can be designed to work in almost any environment such as a desktop application, an internet based application, or simply as a series of internet services designed to communicate with an external application. As noted above, it is possible to produce and manipulate 3D images if multiple fixed position cameras are used to capture images from the event from the same perspective.

In operation, the touchplate may be manipulated using movements already employed for use on smart phones, so that the user can pinch the touchplate (moving two fingers together) to zoom-out, reverse pinch to zoom-in or swipe the touchplate for manipulating field of live performance. These gestures on the touchplate allowing for seamlessly following live streaming performance are provided via a software download or are pre-installed. If desired, selector icons such as a transparent box or cursor may be located on the screen to assist in choosing the part of the image on which the user wishes to zoom in.

The invention requires the TNI, IRI, IMM and RNI to work together, an operation we refer to as “tethering”.

The process of creating the tether can be initiated either at the touchplate or if the RNI is located in a smart TV at the smart TV. In one embodiment, by touching the touchplate, the touchplate initiates a special “seeking-tether” request message that is sent across the network. Smart TVs either download or have pre-installed software that allows it to identify when a touchplate is attempting to create a tether. Tethering can be effected by for example standard zero-configuration networking technologies, such as, by way of example, Apple's Bonjour protocol. Alternatively proprietary software may be used.

In another embodiment, the user utilizes a smart TV's menu options to initiate a seeking of touchplates from the smart TV. Here, the smart TV initiates a “seeking-tether” message that can be received and responded to by the touchplates.

In both embodiments above, the RNI may have available to it one or more possible candidates of touchplates to which it should tether. When the RNI is incorporated into a smart TV, the smart TV can then show a series of actions that should be performed on the touchplate to verify that this is the desired touchplate to which it should tether. For instance, the smart TV could request that the user perform the following sequence of motions on the touchplate: swipe left, swipe right, pinch. After receiving the appropriate sequence of motions, the smart TV can select this touchplate as its tethered controller, and confirm with the touchplate that it is now tethered.

The afore described messages exchanged between touchplate and RNI can be transmitted via several possible physical communication technologies, including but not limited to Wi-Fi, Bluetooth, Ethernet or USB cable. The connection service can also be performed in a more wide area network setting, such as through a cloud service, where the cloud service acts as a proxy between the two devices, and the smart TVs unique identifier and the set of gestures uniquely distinguish the devices wishing to connect.

In another embodiment of the present invention, a software application is downloadable onto smartphones, allowing the smartphone screen to be used identically to the way the touchplate is used, e.g. pinching the smartphone screen (moving two fingers together) to zoom-out, reverse pinching to zoom-in, or swiping the smartphone screen for manipulating the separate monitor view of live performance. In this embodiment, the smartphone screen does not display the live performance, but rather acts as a touchplate. In this embodiment, the live performance is viewed on a separate screen apart from the smartphone screen.

When the live video stream is playing, the user of the touchplate may use their fingers to zoom-in such as by separating two fingers in an outward motion, and may zoom-out such as by moving two fingers together. The streaming video image may also be panned or zoomed-in by steadily reducing the percentage of line displayed on the computer monitor or display screen as the user moves their finger across the touchplate surface. These hand gestures described herein are merely provided as illustrative examples and the present invention is not limited to any particular hand gesture(s) for manipulating the view of a live streaming video. It is anticipated that there may be additional ways of using a touchplate to manipulate the view of a live streaming video and the present invention incorporates all such ways for manipulating the view of a live streaming video by use of a touchplate such as buttons, track-ball, joystick, controller etc.

The touchplate may be hand-held or placed on a table or other physical object, or embedded in a physical object. The touchplate allows a user to manipulate a video image on a smart TV (such as the Bose TV) computer monitor or tablet. The touchplate of the present invention is simply a handheld touchplate, with no viewing screen. The handheld touchplate allows manipulation of the static video (images within it are moving, but the image parameters, the image as a whole does not). The touchplate enables selection of what part of the image is to be viewed including the ability to zoom-in on a particular area of the stage by using two fingers pinching outward, and the ability to zoom-out by using two fingers moving inward to choose a particular degree of magnification. Furthermore, a user can swipe the touchplate to pan across the image being displayed as if moving one's eyes from one side of the stage to the other.

The touchplate is connected to a display screen that may be a smart TV, computer, monitor or tablet The connection may be wirelessly similar to that of a remote control device or may use wire connections similar to those used to control personal entertainment systems on aircraft.

It should be noted that in the method and system of the present invention, the live stream being received by the display device is not viewed on the touchplate (if it were, this would have the undesirable effect of having the user's hand block, and thus interrupt the view of the live video stream).

The touchplate enables manipulation (zoom, area movement) of the static stage shot on televisions, monitors and other display screens (similar to the way one manipulates a photograph or text) and flips viewing choices from others' purview at the performance location to the virtual audience member. The touchplate receives no signal directly from the camera capturing the live event. It simply manipulates the streaming video image on a display screen of the tablet, computer monitor or smart TV that has been programmed to allow the manipulation of the streamed live image. Such programmable capability may come in the form of software that is downloadable onto the display screen via the internet or a CD-ROM disc, or any other means for transferring software onto hardware. The display screen, which may include, but is not limited to, a computer monitor, or tablet or smart TV, receives the streamed video image, not the touchplate.

The touchplate may use known technologies for sensing the touch of the touchplate user. Such touchplate technologies may include, but are not limited to, resistive, surface acoustic wave, capacitive, surface capacitance, projected capacitance, mutual capacitance, self-capacitance, infrared grid, infrared acrylic projection, optical imaging, dispersive signal, and acoustic pulse recognition sensing technologies. These touch sensing technologies are merely provided as illustrative examples and the present invention is not limited to any one particular technology. It is anticipated that touch sensing technologies will be improved and that new touch sensing technologies will be developed, and the present invention is intended to incorporate all known and future developed touch sensing technologies.

The viewing system and method of this invention embodies touchplate capability via viewers hand gestures on the air (rather than on a plate or device) that are recorded by cameras within the smart screen, converted to digital and used by the smart screen IMM to manipulate the static framed moving image.

Devices such as the iPad and the MacBook Air inadvertently permit some manipulation of some video images by touch. Similar software can be used to provide manipulation of a stream of images originating from a single camera (or more for 3D viewing) as in the present invention, the difference being that in the present invention, there is transmission of the command from the touchplate to the receiver to act on the incoming data stream rather than both command and execution being affected in the same device.

The incoming data stream contains commands for each picture element to be displayed on the screen and different television systems have different numbers of these and arrange them in different ways. In the present invention, the commands from the touchplate suppress some of the incoming commands received by the display screen by determining which pixels are to be activated on the display screen, thereby “tethering” the image to be displayed.

The touchplate can connect directly to a display screen, such as a smart TV, computer monitor, or tablet, through wireless connections such as infrared (IR), radio frequency (RF), WIFI or Bluetooth, or can communicate with the smart TV via a network, such as through the Cloud or relevant gateway The touchplate will include a transmitter, either built-in or plugged-in to the USB port, to communicate with a receiver included in the display screen. The touchplate will also include an AC power connection or batteries for power. The signal data of the user's finger movements transmitted from the touchplate is monitored by a controller incorporated into the smart TV, computer, monitor or tablet. The controller is an integrated circuit (IC) that processes all of the touchplate data that comes from the touchplate and forwards it to the network interface of the smart TV, computer monitor or tablet. When the operating system is notified that there is data transmitting from the touchplate, it passes the touchplate data on to the application running the video stream. The application then accepts the touchplate data for manipulating the streaming video image being received by the display screen.

In one embodiment, the touchplate communicates with the network interface to connect to the display screen, such as a smart TV, computer monitor or tablet, through radio frequency (RF). In this embodiment, a transmitter will be housed in the touchplate to send electromagnetic (radio) signals that encode information about the movement of the user's hand on the touchplate as well as certain hand gestures by the user on the touchplate that communicate commands to the application running the streaming video such as the hand gesture of touching the touchplate in two quick successive motions or pinching two fingers together for zooming-out on a particular area of the streaming video. The display screen will include a receiver for accepting the electromagnetic (radio) signals from the touchplate and decoding the signals before sending the signals to the operating system of the display screen. The receiver can be a separate device that plugs into the display screen or can be a built-in component of the display screen. The transmitter in the touchplate and the receiver in the display screen may be pre-paired or may require a pairing sequence. The transmitter in the touchplate may also include an encryption scheme or employ a frequency hopping method for protecting the signal sent from the transmitter to the receiver of the display screen.

In another embodiment of the present invention, the touchplate may communicate with the operating system of a display screen, such as a smart TV, computer monitor or tablet, by way of Bluetooth technology.

In another embodiment of the present invention, the touchplate may communicate with the operating system of a display screen, such as a smart TV, computer monitor or tablet, by way of Wi-Fi.

In another embodiment of the present invention, the touchplate may communicate with the operating system of a display screen, such as a smart TV, computer monitor or tablet, by way of Ethernet cable.

In another embodiment of the present invention, the touchplate communicates with the operating system of the display screen by a USB cable that connects the touchplate with the display screen.

Display screen equipment that may be used in the method and system of the present invention may include any type of display screen that is capable of having software installed for manipulating the view of live streaming video so that only a portion of the feed is being displayed on the display screen such that zooming and panning of the displayed live streaming video on the display screen image is possible. Such display screens include smart TVs, computer monitors, and tablets or any other device capable of receiving and displaying streaming video. The display area of the display screen can be arranged with graphical icons and/or other user controls that when activated, perform specific functions such as zooming in and out. Such icons and user controls are activated by the user by using the touchplate. The smart TVs, computer monitors or tablets display screen equipment is configured for receiving video data from a single high definition video camera and sound data from a microphone or multiple microphones by having a receiver for receiving the video and sound data.

The receiver can be a separate device that plugs into the smart TV, computer monitor or tablet or can be a built-in component. The receiver can communicate with the various components of the smart TV, computer monitor or tablet such as the central processing unit (CPU), image processing unit and memory units. In cases where data encoding the images are supplied in encrypted form, such display screen will include a processor programmed to decrypt the incoming data. The display area of the smart TV, computer monitor or tablet can be arranged with graphical icons and/or other user controls that when activated, perform specific functions such as zooming in and out. Such icons and user controls that appear on the display area are activated by the user by using the touchplate.

An embodiment of the present invention includes a system comprising a single high definition video camera with an encoder which compresses and transmits the video data being recorded by the camera via a general means of distribution for distributing a signal. The general means of distribution for distributing a signal will have a receiver for receiving the video data transmitted from the video camera. The general means of distribution for distributing a signal is capable of transmitting the video data, after processing and formatting the video data received from the video camera and for distributing the video data, to a receiver for display on screen smart TV, computer monitor or tablet. Such general means of distribution may include means for distributing the video data on the internet so that it may be accessed by subscribers of an internet streaming network.

In another embodiment of the present invention, the system may incorporate a microphone or multiple microphones for capturing the sound of the live performance in addition to the components specified in the above embodiment. The microphones have a transmitter for transmitting the captured sound data to a general means of distribution for distributing a signal. The general means of distribution for distributing a signal will have a receiver for receiving the sound data transmitted from the microphones. The general means of distribution for distributing a signal will also have a transmitter for transmitting the sound data after processing and formatting the sound data received from the microphones, and for distributing the sound data, to a receiver of the a display screen smart TV, computer monitor or tablet. Such general means for distributing a signal may include means for distributing the sound data on the internet so that it may be accessed along with video data by subscribers of an internet streaming network.

Another embodiment of the present invention is a method that includes the steps of capturing video data of the theatrical performance by an ultra-high-definition video camera (or 4K or higher) with wide angle lens; transmitting the video data through an encoder and transmitter with the video camera to a general means of distribution for distributing a signal which may include means for distributing video content on the internet; processing and formatting the video data; transmitting the video data from the general means of distribution for distributing a signal to a receiver incorporated into the a receiver of a display screen smart TV, computer monitor or tablet; transmitting the video data from the receiver of the display screen smart TV, computer monitor or tablet to the network interface of the display screen smart TV, computer monitor or tablet; transmitting the video data to the appropriate software applications installed on the display screen and hardware to produce an output of live streaming video that can be manipulated by a user such that zooming and panning of the live streaming video on the display screen is possible.

In another embodiment of the present invention, the method may include the steps of capturing video data by a high definition video camera with wide angle lens and capturing sound data by a microphone or multiple microphones of a live theatrical performance; transmitting the video and sound data by transmitters incorporated in the high definition video camera and microphone(s) to a general means of distribution for distributing a signal which may include means for distributing video and sound content on the internet; processing and formatting the video and sound data; transmitting the video and sound data from the general means of distribution for distributing a signal to a receiver of a display screen incorporated into the smart TV, computer monitor or tablet; transmitting the video and sound data from the receiver of the display screen smart TV, computer monitor or tablet to the operating system of the display screen smart TV, computer monitor or tablet; transmitting the video and sound data to the appropriate software applications installed on the display screen and hardware so that an output of live streaming video that can be manipulated, seen and heard by a user such that zooming and panning of the live streaming video on the display screen is possible.

The general means for distributing a signal to the receiver of the smart TV, computer monitor or tablet may utilize a variety of possible wired and wireless communications and networking configurations. Such means for distributing a signal may include traditional broadcasting means as well as more modern systems such as cellular, satellite, Bluetooth, WI-Fi, and RF or direct IR communications. A wireless network may be implemented as a single network type (e.g. Bluetooth) or may be based on a combination of network types (e.g. GSM, CDMA, etc.). A Wireless network can be configured with the teachings of CDPD (Cellular Digital Packet Data) networks, Personal Area Networks or Bluetooth, GSM (Global System for Mobile Communication) and PCS (Personal Communications Systems) networks, GPRS networks CDMA (Code Division Multiple Access) networks and wideband CDMA (W-CDMA) networks, TDMA (Time Division Multiple Access) networks, and Wireless Intelligent Networks (WINs), and Wi-Fi.

Although live video and sound data is transmitted from the video camera to the general means of distribution for distributing a signal and then transmitted to the display screen smart TV, computer monitor or tablet, all happening almost instantaneously, another embodiment of the invention allows the captured video and sound data to be stored in the general means of distribution for distributing a signal and later transmitting the video and sound data to the display screen smart TV, computer monitor or tablet.

The present invention allows virtual audience attendance at stage performance and live events. It enables the viewer at home to be like a seated audience member: the viewer at home will be able to view an actor or costume or section of stage, as desired, in real time, without the dictates of a technical director. A single camera can be located at a convenient viewing position in the auditorium of a theater, opera house or concert hall where a performance is taking place allowing a live stage performance broadcast or streamed video via one ultra high-definition camera with stage specific lens (or cameras with stage specific lenses for 3D) at acquisition. The camera is stationary and immobile. This means no additional rehearsals, no change in the actors' performance for camera, and no changes required on stage. Furthermore, the entire theatre audience is unaffected (unlike the situation where multiple cameras at various perspectives and heights, often tilting, and moving for shots, are employed).

The description and embodiments set forth herein are presented in order to best explain the present invention and to thereby enable those skilled in the art to make and utilize the invention. However, those skilled in the art will recognize that the forgoing description and embodiments have been presented for the purpose of illustration and example only. The description as set forth is not intended to be exhaustive or to limit the invention to the precise form disclosed. Many modifications and variations are possible in light of the above teaching without departing from the spirit and scope of the present invention.

1. A method for viewing an event captured from a single perspective at a wide angle by one or more cameras which comprises receiving a stream of images captured by said cameras by a receiver comprising a display screen, said receiver being connected to a separate touchplate, said touchplate is adapted to control which parts of said images are displayed on the display screen.

2. The method as claimed in claim 1 wherein said connection between the touchplate and the display screen is digital.

3. The method as claimed in claim 1 wherein said touchplate enables zooming and panning features.

4. The method as claimed in claim 1 wherein the touchplate receives no data.

5. The method as claimed in claim 1 wherein the touchplate communicates with the display screen wirelessly.

6. The method as claimed in claim 1 wherein the display screen is incorporated in a smart TV, tablet or personal computer.

7. The method as claimed in claim 1 wherein a second receiver connects to and views the stream.

8. The method as claimed in claim 1 wherein the touchplate initiates a configuration procedure with the viewing system to enable tethering of an image modifier module, an image receiver interface and receiver/touchplate network interface: to interact with the incoming stream to manipulate the image displayed.

9. A system for viewing an event captured from a single perspective at a wide angle by one or more cameras which comprises receiving a stream of images captured by said camera, which system comprises a receiver comprising a display screen, said receiver being connected to a touchplate adapted to control which parts of said images are displayed on the display screen.

10. A system as claimed in claim 9 wherein the stream received derives from more than one camera to produce a display having three dimensional appearance.

11. The system as claimed in claim 9 wherein said connection between the touchplate and the display screen is digital.

12. The system as claimed in claim 9 wherein said touchplate enables zooming and panning features.

13. The system as claimed in claim 9 wherein the touchplate is not enabled to receive data.

14. The method as claimed in claim 9 wherein the touchplate communicates with the display screen wirelessly.

15. The method as claimed in claim 9 wherein the display screen is incorporated in a smart TV, tablet or personal computer.

16. The system as claimed in claim 9 wherein the system enables a second receiver connects to and views the stream.

17. The system as claimed in claim 9 wherein the touchplate initiates a configuration procedure with the viewing system to enable tethering of an image modifier module, an image receiver interface and a receiver/touchplate network interface to enable interaction with the incoming data stream to manipulate the image displayed on the display screen.

18. A touchplate for use in the system of claim 9 which comprises a touchscreen responsive to commands given by movement of a finger or device on its surface and software programmed to transmit commands to a receiver/touchplate network interface to manipulate a streaming data feed feeding a stream of images to remote display screen.
